(19) United States
(12) Patent Application Publication
(10) Pub. No.: US 2004/0263536 A1
(43) Pub. Date: Dec. 30, 2004

(54) Image processing method and apparatus

(76) Inventor: Yutaka Owada, Tokyo (JP)

Correspondence Address: CANTOR COLBURN LLP, 55 Griffin Road South, Bloomfield, CT, 06002, US

(21) Appl. No.: 10/877,383

(22) Filed: Jun. 25, 2004

(30) Foreign Application Priority Data
Jun. 27, 2003 (JP) JP2003-184022

(51) Int. Cl. G09G 5/00

(52) U.S. Cl. 345/645; 345/679; 345/606; 345/632

(57) ABSTRACT

A technology for improving the reality of images created by computer graphics. A modeling unit performs basic modeling on objects. An object classification unit determines the presence or absence of target objects of coordinate transformation. If there is any target object of coordinate transformation, a coordinate transformation unit performs coordinate transformation on the target object of the coordinate transformation. An object adjustment unit adjusts the positional relationship between the object given coordinate transformation and objects given no coordinate transformation, thereby reflecting the positional relationship between the objects before the coordinate transformation.

### BACKGROUND OF THE INVENTION

1. Field of the Invention

The invention relates to an image processing technology. In particular, the invention relates to a method and an apparatus for applying image processing to an object to be rendered in 3D computer graphics.

2. Description of the Related Art

With the improvement of computer throughput, computer graphics is recently being used in various scenes for visual representation. Highly realistic images are now used in game machines and the like, and it is not uncommon to create the display images by using 3D computer graphics. For maximum visual reality and a variety of additional effects on images, various technologies are expected to be introduced into the field of 3D computer graphics in the future. Among such technologies are proposed techniques for enhancing presence of 3D computer graphics used in game machines and the like (for example, see Japanese Patent Laid-Open Publication No. 2001-134748 (full text)).

Japanese Patent Laid-Open Publication No. 2001-134748 proposes a method of displaying 3D animation, in which two objects in question are set on a 2D screen while a virtual camera is controlled in arrangement for enhanced presence. In the field of 3D computer graphics, it is desirable to make studies from various angles for improved visual quality, new graphic effects, etc.

### SUMMARY OF THE INVENTION

The present invention has been achieved in view of the foregoing. It is thus an object of the present invention to provide a technology for improving the reality of an image to be rendered in computer graphics. Another object of the present invention is to provide a technology for improving or adding effects renderable in computer graphics.

One of the aspects of the present invention provides an image processing method. In this method, a moving image is generated by using 3D computer graphics while nonlinear coordinate transformation is applied to original moving-image data.

Another aspect of the present invention provides an image processing apparatus. This apparatus is an image processing apparatus which generates a moving image by using 3D computer graphics, comprising: an object classification unit which classifies a plurality of objects included in an original moving image into first and second objects to be rendered relatively larger and smaller, respectively; and a transformation unit which applies nonlinear coordinate transformation to an object classified as the first object. Consequently, this image processing apparatus can apply the coordinate transformation to larger objects.

Still another aspect of the present invention also provides an image processing apparatus. This apparatus is an image processing apparatus which generates a moving image by using 3D computer graphics, comprising: an object classification unit which classifies a plurality of objects included in an original moving image into first and second objects having relatively larger and smaller amounts of movement, respectively; and a transformation unit which applies nonlinear coordinate transformation to an object classified as the first object. For example, a stationary object may be classified as the first object, and a moving object as the second object. Consequently, this image processing apparatus can apply the coordinate transformation to objects having larger amounts of movement.

The transformation unit may not apply the nonlinear coordinate transformation to the second object. According to this aspect, the image processing apparatus may further comprise a positional relationship adjustment unit which makes the positional relationship between the first and second objects in the original moving image be reflected in the positional relationship between the first object given coordinate transformation and the second object given no coordinate transformation.

The transformation unit may apply nonlinear coordinate transformation to the second object. The nonlinear coordinate transformation to the first object may be applied first. The nonlinear coordinate transformations to the first and second objects may be identical to or different from each other.

Still another aspect of the present invention also provides an image processing apparatus. This apparatus is an image processing apparatus which generates a moving image by using 3D computer graphics, comprising: an object classification unit which classifies a plurality of objects included in an original moving image into first and second objects to be rendered relatively larger and smaller, respectively; and a transformation unit which changes the shape of an object classified as the first object. Consequently, this image processing apparatus can change the shape of larger objects.

Still another aspect of the present invention also provides an image processing apparatus. This apparatus is an image processing apparatus which generates a moving image by using 3D computer graphics, comprising: an object classification unit which classifies a plurality of objects included in an original moving image into first and second objects having or making relatively larger and smaller amounts of movement, respectively; and a transformation unit which changes the shape of an object classified as the first object. For example, a stationary object may be classified as the first object, and a moving object as the second object. Consequently, this image processing apparatus can change the shape of objects having or making larger amounts of movement.

The transformation unit may not change the shape of the second object. According to this aspect, the image processing apparatus may further comprise a positional relationship adjustment unit which makes the positional relationship between the first and second objects in the original moving image be reflected in the positional relationship between the first object changed in shape and the second object unchanged in shape.

The transformation unit may change the shape of the second object. The shape of the first object may be changed first.

The transformation unit may change the shape of the object while applying nonlinear coordinate transformation to the object so that an area rendered as a plane has a desired curvature. Incidentally, the desired curvature may be a curvature required of the entire object to be changed, or curvatures required of respective subsections of the entire object.

Incidentally, any combinations of the foregoing components, and the expressions of the present invention converted among methods, apparatuses, systems, recording media, and the like are also intended to constitute applicable aspects of the present invention.

### BRIEF DESCRIPTION OF THE DRAWINGS

FIGS. 1(a) to 1(c) are diagrams showing two buildings standing on the surface, in three types of rendering modes;

FIGS. 2(a) to 2(c) are diagrams showing the positional relationship of the buildings to the surface shown in FIG. 1, in the form of vectors with respect to the surface;

FIGS. 3(a) and 3(b) are diagrams showing the surfaces before and after coordinate transformation as viewed obliquely from above;

FIGS. 4(a) to 4(c) are diagrams showing an example of a method of transformation from a plane to a spherical surface;

FIGS. 5(a) and 5(b) are diagrams showing the result of a simulation in which a plane provided with a number of perpendicular vectors is transformed into a spherical surface through coordinate transformation;

FIG. 6 is a block diagram of an image processing apparatus according to an embodiment; and

FIG. 7 is a flowchart pertaining to the operation of the image processing apparatus, showing the procedure for coordinate transformation in particular.

### DETAILED DESCRIPTION OF THE PREFERRED EMBODIMENTS

In 3D computer graphics, for example, the surface of the Earth (hereinafter, also referred to simply as “the surface”) is often rendered as a plane, and the border between the surface and the sky as a horizon line, i.e., a straight line. The surface can be approximated to a plane microscopically, whereas it may preferably be rendered as a spherical surface since the Earth is spherical in shape. For example, in game and other situations where the ground is viewed from the sky above, users viewing a flat surface may have a feeling of strangeness. Then, in the present embodiment, moving images are displayed in 3D computer graphics with a curvature given to the plane-rendered surface so that the surface looks spherical.

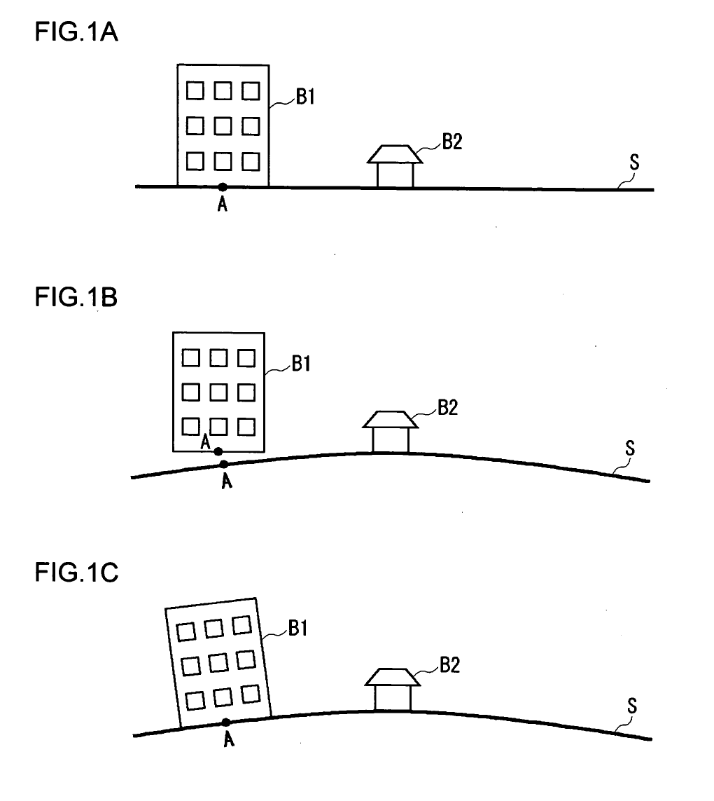

FIGS. 1(a) to 1(c) show two buildings B1 and B2 standing on the surface S, in three types of rendering modes. The buildings B1, B2 and the surface S are rendered as respective objects. FIG. 1(a) shows the situation where the two buildings B1 and B2 stand on the surface S which is rendered horizontal. Incidentally, the surface S is considered as an object that can be rendered to have a curvature.

FIG. 1(b) shows the situation where coordinate transformation is conducted so that the object, or the surface S, has a curvature. Here, the surface S alone is subjected to the coordinate transformation, and neither of the buildings B1 and B2 is. As a result, while the building B2 at the center is in contact with the surface S, the building B1 displayed on the left lies apart from the surface S. Specifically, the building B1 on the left and the surface S are in contact with each other at point A in FIG. 1(a), whereas they are apart from each other in FIG. 1(b). The latter image is undesirable. Then, in the present embodiment, as shown in FIG. 1(c), the building B1 is adjusted in arrangement so that the building B1 and the surface S make contact at point A and the building B1 is perpendicular to the surface S.

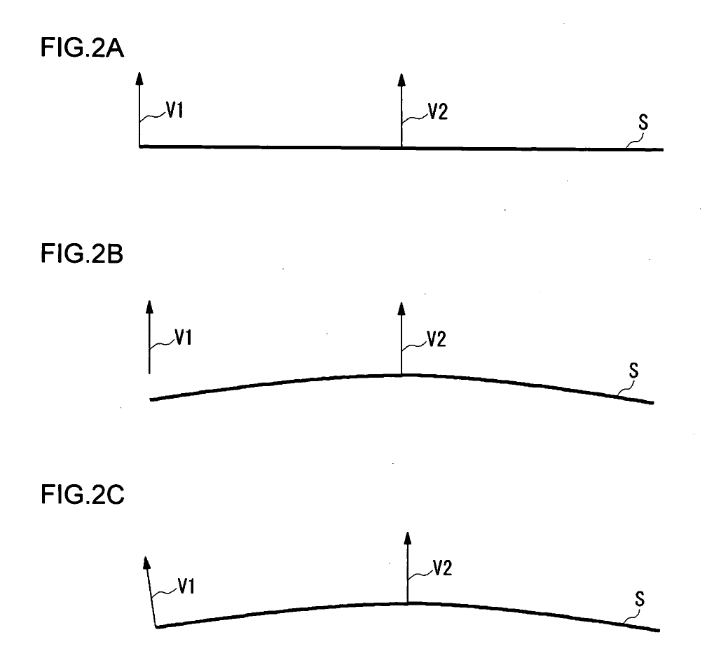

FIGS. 2(a) to 2(c) show the positional relationship of the buildings B1 and B2 to the surface S shown in FIGS. 1(a) to 1(c), in the form of vectors with respect to the surface S. FIG. 2(a) corresponds to FIG. 1(a), and shows two vectors V1 and V2 perpendicular to the surface S which is rendered as a straight line. The vector V1 corresponds to the building B1, and the vector V2 the building B2. FIG. 2(b) corresponds to FIG. 1(b), and shows the situation where the curvature is reflected on the surface S. At this stage, the two vectors V1 and V2 are not adjusted in positional relationship. The starting point of the vector V1 thus lies apart from the surface S. FIG. 2(c) corresponds to FIG. 1(c), and shows the situation where predetermined processing for positional adjustment is applied to the vector V1 of FIG. 2(b) so that the staring point of the left vector V1 is in contact with the surface S given coordinate transformation and the vector V1 is perpendicular to the surface S.

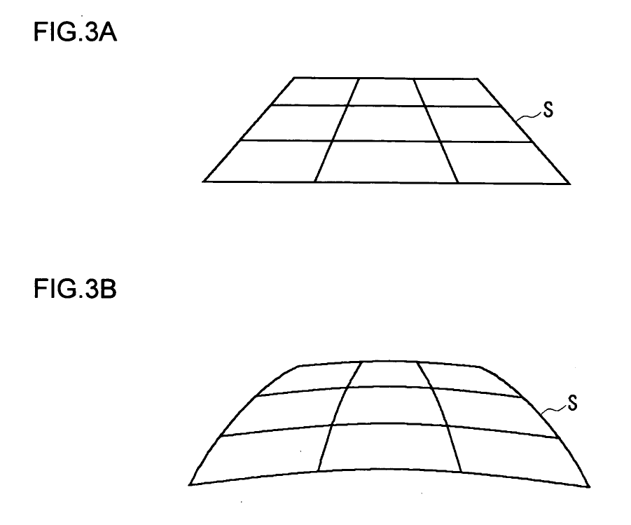

FIGS. 3(a) and 3(b) show the surface S being viewed obliquely from above. FIG. 3(a) shows the situation where the surface S is rendered as a plane. FIG. 3(b) shows the situation where a curvature is reflected on the surface S.

For example, in 3D computer graphics such as a game, the surface S is often rendered as approximated to a plane as shown in FIG. 3(a). With airplane-flying games, flight simulators, and the like, the surface S can be approximated to a plane as shown in FIG. 3(a) without the user having a feeling of strangeness from the displayed relationship between the airplane and the surface S, as long as the airplane flies near the surface S. To show situations where the airplane is somewhat away from the surface S, it is preferable in view of reality that the surface S is rendered as a part of a spherical surface as shown in FIG. 3(b).

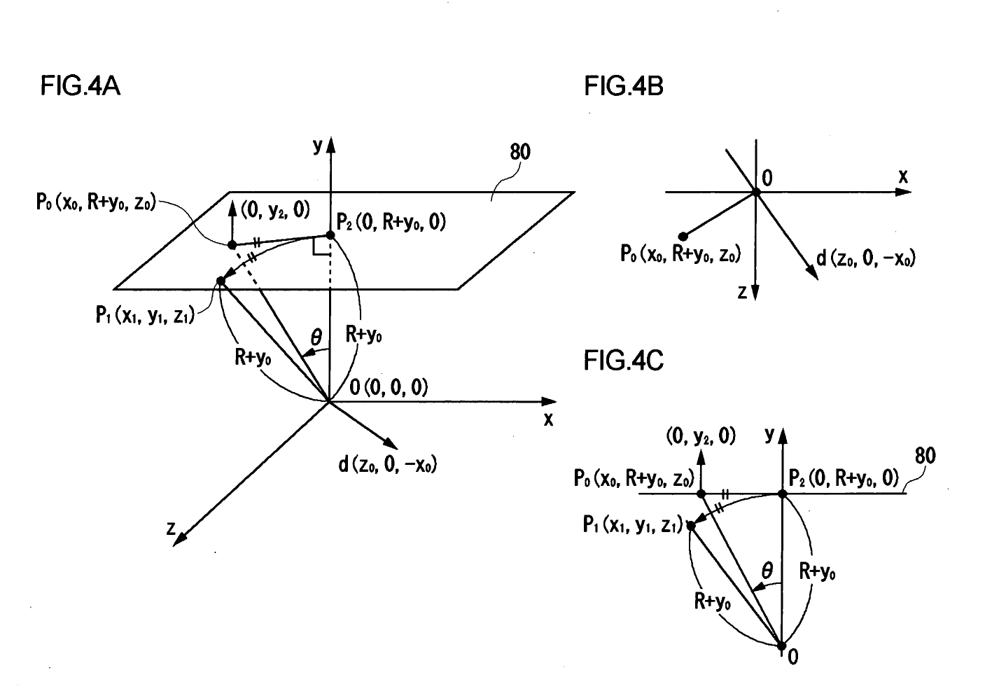

FIGS. 4(a) to 4(c) show an example of the method of coordinate transformation from a plane to a spherical surface. FIG. 4(a) shows xyz coordinate systems in which point P₀(x₀, R+y₀, z₀) lies on a plane 80 of y=(R+y₀). Here, the point P₀ shall correspond to a certain point on the surface S. When the plane 80 is transformed into a spherical surface through coordinate transformation, the point P₀(x₀, R+y₀, z₀) is transferred to point P₁(x₁, y₁, z₁). FIG. 4(b) is a diagram showing the point P₀ as viewed from the y-axis. FIG. 4(c) is a diagram showing the point P₀ as viewed from the z-axis. The distance from the surface S to the origin O, or the center of the Earth, is R. The distance between the plane 80 and the surface S is y₀. If the plane 80 represents the surface S, y₀ is 0. Points on the y-axis are fixed points in the coordinate transformation from the plane to the spherical surface.

From x₀ and z₀ of the point P₀(x₀, R+y₀, z₀), the angle of rotation θ and a unit vector d for indicating the axis of rotation with respect to the spherical surface (hereinafter, also referred to simply as “the axis of rotation d”) are determined. Suppose here that the angle of rotation θ is sufficiently small, i.e., the distance from the y-axis to the point P₀ is sufficiently smaller than R (R>>y₀) which corresponds to the radius of the Earth. This yields the angle of rotation θ=(x₀²+z₀²)^{1/2}/R and d=(z₀/(x₀²+z₀²)^{1/2}, 0, −x₀/(x₀²+z₀²)^{1/2}) Consequently, the point P₁ is determined by giving a rotation determined by the foregoing angle of rotation θ and the axis of rotation d to point P₂(0,R+y₀,0) Incidentally, the curve from the point P₁ to the point P₂ and the line from the point P₀ to the point P₂ have the same length. For example, a vector (0, Y₂, 0) that starts at the point P₀(x₀, R+y₀, z₀) and is perpendicular to the plane 80 ends at a position of (x₀, R+y₀+y₂, z₀) before coordinate transformation. The position after coordinate transformation may thus be determined by giving the foregoing rotation determined by the angle of rotation θ and the axis of rotation d to a point (0, R+y₀+y₂, 0).

There are several transformation formulas for giving the foregoing rotation determined by the angle of rotation θ and the axis of rotation d. The examples include ones expressed as the following rotation matrix and quaternion. These transformation formulas can be used to apply the nonlinear coordinate transformation to an object.

1. Rotation Matrix Formula

Assuming that the axis of rotation d is (x, y, z), the transformation for rotating by θ about the axis of rotation d is expressed as the following matrix:

$$( \begin{matrix}xx ( 1 - cos θ ) + cos θ & xy ( 1 - cos θ ) - z sin θ & xz ( 1 - cos θ ) + y sin θ \\ yx ( 1 - cos θ ) + z sin θ & yy ( 1 - cos θ ) + cos θ & yz ( 1 - cos θ ) - x sin θ \\ zx ( 1 - cos θ ) - y sin θ & zy ( 1 - cos θ ) + x sin θ & zz ( 1 - cos θ ) + cos θ\end{matrix} )$$

Under the condition shown in FIGS. 4(a)-4(c), the axis of rotation d is given by (z₀/(x₀²+z₀²)^{1/2}, 0, −x₀/(x₀²+z₀²)^{1/2}). Thus:

x=z₀/(x₀²+z₀²)^{1/2}

y=0, and

z=−x₀/(x₀²+z₀²)^{1/2}.

2. Quaternion

Quaternions are used to express rotation in 3D computer graphics. In transforming coordinates based on a quaternion, the quaternion is expressed as a matrix for application. A quaternion having components of (w, x, y, z) is typically expressed as the following matrix:

$$( \begin{matrix}1 - 2 ( yy + zz ) & 2 ( xy - wz ) & 2 ( xz + wy ) & 0 \\ 2 ( xy + wz ) & 1 - 2 ( xx - zz ) & 2 ( yz - wx ) & 0 \\ 2 ( xz - wy ) & 2 ( yz + wx ) & 1 - 2 ( xx + yy ) & 0 \\ 0 & 0 & 0 & 1\end{matrix} )$$

Assuming that the axis of rotation d is (xₚ, yₚ, zₚ), the transformation for rotating by θ about the axis of rotation d is expressed as the following quaternion q:

q=(cos 2θ, xₚ sin 2θ, yₚ sin 2θ, zₚ sin 2θ).

Consequently, in the foregoing matrix, the rotation is expressed by substituting w=cos 2θ, x=xₚ sin 2θ, y=yₚ sin θ, and z=zₚ sin 2θ.

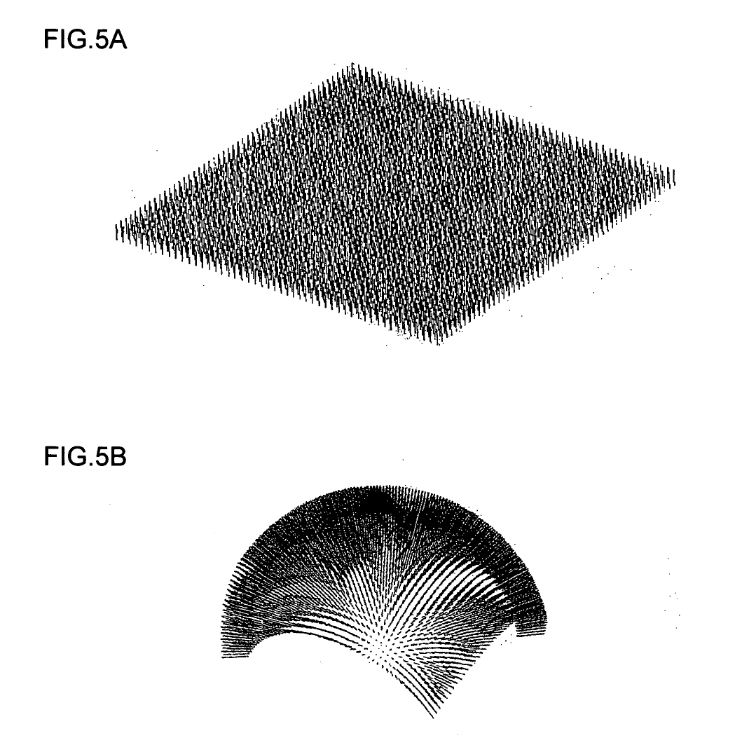

FIGS. 5(a) and 5(b) show the result of a simulation in which a plane provided with a number of perpendicular lines is transformed into a spherical surface through coordinate transformation. This simulation result is obtained by applying the foregoing matrix or quaternion. FIG. 5(a) shows the state of the object, or plane, having a number of perpendicular lines before the coordinate transformation. FIG. 5(b) shows the situation after the plane is transformed into a spherical surface through the coordinate transformation.

Hereinafter, description will be given of an image processing apparatus to which the foregoing technique for transforming a plane into a spherical surface through coordinate transformation is applied. The following will deal with an image processing apparatus for providing a moving-image game in 3D computer graphics. In the image processing apparatus, objects to appear on a scene are classified into larger and smaller objects, or more particularly, surface and other objects. Coordinate transformation processing is applied to the object that represents the surface.

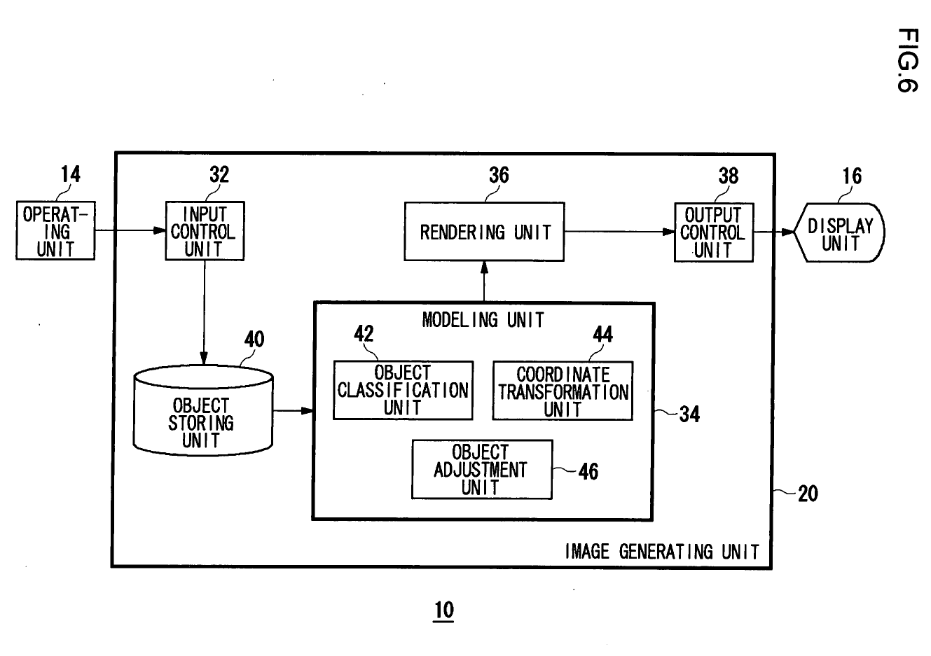

FIG. 6 shows the configuration of an image processing apparatus 10 having an image generating unit 20 according to the present embodiment. The image processing apparatus 10 comprises an operating unit 14, an image generating unit 20, and a display unit 16. The operating unit 14 accepts user operations. The image generating unit 20 generates images to display based on the operations by using 3D computer graphics. The display unit 16 displays the generated images.

The image generating unit 20 comprises an input control unit 32, a modeling unit 34, a rendering unit 36, an output control unit 38, and an object storing unit 40.

The object storing unit 40 stores the data on objects to be arranged on a scene. For example, an object that represents the surface is stored in the form of data describing a flat state. In the example of FIGS. 5(a) and 5(b), the stored data describes the plane of the object that makes the contact surface with the plurality of vertical lines. This object rendering mode has been commonly used for computer graphics descriptions. Thus, in the present embodiment, creators who create moving image data, or data on such objects as the surface, have only to create flat data as has been. This eliminates the need to take account of complicated curvatures etc.

The input control unit 32 controls screen generation in accordance with the progress of the game, based on user operations from the operating unit 14. More specifically, the input control unit 32 selects objects necessary for a scene from the object storing unit 40, and determines the arrangement of the same.

The modeling unit 34 models the objects to appear on a scene. Specifically, for example, an object is rendered in polygons, and an object is rotated or moved. The foregoing constitutes typical processing of the modeling unit 34. The foregoing processing will hereinafter be referred to also as “basic modeling.”

The modeling unit 34 comprises an object classification unit 42, a coordinate transformation unit 44, and an object adjustment unit 46 for the sake of performing coordinate transformation for reflecting a curvature on the surface, aside from the basic modeling. The object coordinate transformation processing by the object classification unit 42, the coordinate transformation unit 44, and the object adjustment unit 46 will be referred to as “extended modeling.”

The object classification unit 42 selects an object to be subjected to coordinate transformation, or the object representing the surface in particular, from among a plurality of objects to appear on a scene. The object classification unit 42 may select all objects that reach or exceed a predetermined size as the targets of coordinate transformation. The object classification unit 42 may determine the sizes of the objects based on data as to the shapes of the objects, or by referring to parameters which are set for the respective objects in advance. With the parameters, conditions other than size can be used as the criteria for determining which objects are the targets of coordinate transformation and which not. For example, coordinate transformation can be targeted at objects intended by the contents creator. Moreover, the object classification unit 42 may determine whether the amounts of movement of the objects are large or small, or if the objects are moving or stationary, for example. Then, it may determine stationary objects as the targets of coordinate transformation.

The coordinate transformation unit 44 performs coordinate transformation on the object(s) selected by the object classification unit 42 so that a curvature corresponding to the radius of the Earth is reflected on the surface. Note that the radius of the Earth need not necessarily be reflected with precision, but may be determined arbitrarily by the contents creator. The contents creator may determine the curvature according to desired graphic effects. The processing of the coordinate transformation unit 44 brings the objects modeled as in FIG. 1(a), for example, into the state as shown in FIG. 1(b) where a curvature is reflected on the surface. Curvatures may be given to smaller objects, whereas the resulting visual effects are smaller than with larger objects. In view of reducing the load on the coordinate transformation unit 44, it is of significance to determine targets of the coordinate transformation processing depending on the object sizes. When the amount of movement of an object is larger, the object will be remodeled more frequently. Reflecting a curvature on such an object can thus increase the load on the coordinate transformation unit 44. Consequently, in view of reducing the load on the coordinate transformation unit 44, it is also of significance to determine targets of the coordinate transformation processing depending on the amounts of movement of the objects.

If objects on a scene include ones given coordinate transformation by the coordinate transformation unit 44, the object adjustment unit 46 adjusts the arrangement of the objects given coordinate transformation and that of the objects given no coordinate transformation, thereby providing scene consistency. For example, the object adjustment unit 46 and the coordinate transformation unit 44 adjust the arrangement of the objects as shown in FIG. 1(b) into the state of FIG. 1(c). Moreover, after the curvature is given to the plane of the scene shown in FIG. 5(a) by the coordinate transformation unit 44, the object adjustment unit 46 adjusts the positions and directions of the perpendicular lines to generate the image shown in FIG. 5(b). Incidentally, all the objects included in a scene may be subjected to the coordinate transformation. Coordinate transformation algorithms may be set for respective objects.

Moreover, in consideration of the processing load, when all the objects are subjected to coordinate transformation, they may also be classified into larger and smaller objects so that the larger objects are given the coordinate transformation in advance and the smaller objects are given the coordinate transformation at timing necessary for display. More specifically, it is sometimes known in advance that certain objects appear on the next scene in view of the progress of the game. In particular, objects to be shown in the background are often known. Such objects are preferably modeled and, if necessary, given coordinate transformation in advance.

The data on the modeled objects is transmitted to the rendering unit 36. The rendering unit 36 generates a 3D image from the stereoscopic data on the modeled objects, projects the generated 3D image onto a 2D space, and creates a scene rendered in the 2D space.

The output control unit 38 converts the scene created by the rendering unit 36, rendered in the 2D space, into signals to be displayed on the display unit 16 such as RGB signals. The output control unit 38 outputs the signals to the display unit 16.

In terms of hardware, the foregoing configuration can be achieved by such components as a CPU of an arbitrary computer, a memory, and other LSIs. In terms of software, it can be achieved by a program having image processing functions which is loaded on the memory. The functional blocks shown here are achieved by the cooperation of these. It will thus be understood by those skilled in the art that these functional blocks may be achieved in various forms including hardware alone, software alone, and combinations thereof.

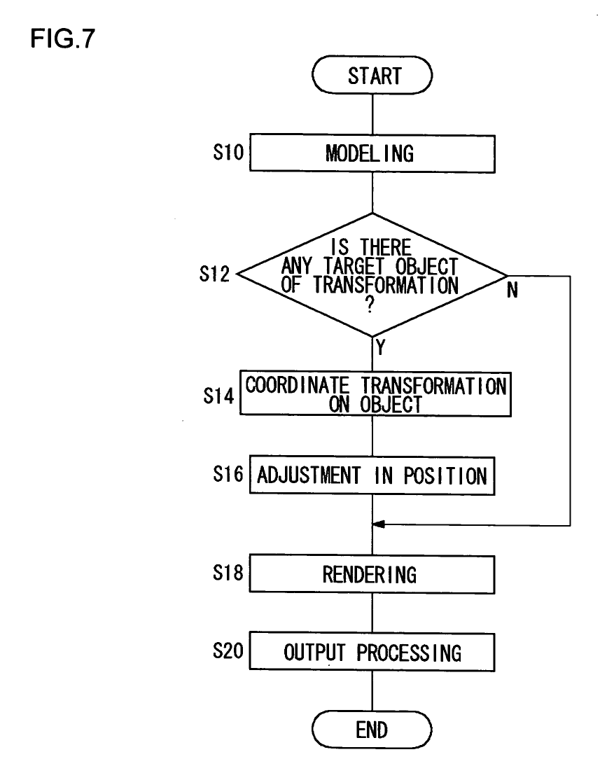

FIG. 7 is a flowchart pertaining to the operation of the image processing apparatus 10 having the foregoing configuration, showing the procedure for coordinate transformation in particular. Receiving a user operation, the input control unit 32 selects objects to be displayed on a scene from the object storing unit 40. The modeling unit 34 performs basic modeling on the selected objects (S10).

When the basic modeling is completed, the object classification unit 42 determines the presence or absence of target objects of the extended modeling, i.e., for coordinate transformation (S12). If there is any target object of coordinate transformation (Y at S12), the coordinate transformation unit 44 performs coordinate transformation on the target object of the coordinate transformation (S14). The object adjustment unit 46 adjusts the positional relationship between the object given coordinate transformation and objects given no coordinate transformation, thereby reflecting the positional relationship between the objects before the coordinate transformation (S16).

If there is no target object of coordinate transformation at S12 (N at S12), or when the adjustment of the positional relationship is completed at S16, the rendering unit 36 conducts rendering (S18). The output control unit 38 converts the resultant into data to be displayed on the display unit 16, and performs output processing (S20).

Consequently, moving images rendered in 3D computer graphics can be improved in reality. Moreover, even if curvatures which objects to be rendered in 3D computer graphics originally have are not reflected on the objects, it is possible to select objects desirable for curvatures to be reflected on and perform coordinate transformation on the objects. Consequently, conventional object data can be used as is, and conventional object description methods can be used even in creating new contents. That is, contents creators may write object data without considering which object should be subjected to coordinate transformation.

Up to this point, the present invention has been described in conjunction with the embodiment thereof. This embodiment has been given solely by way of illustration. It will be understood by those skilled in the art that various modifications may be made to combinations of the foregoing components and processes, and all such modifications are also intended to fall within the scope of the present invention. The following provides some of the modifications.

In the embodiment, the coordinate transformation is performed for the sake of giving a curvature to a plane. The coordinate transformation is not limited thereto, but may be performed to change the shapes of objects. That is, objects to appear on a scene are classified into target and non-target objects of the shape change, and the objects classified as the targets of the shape change are changed in shape. This can be achieved, for example, by replacing the coordinate transformation unit 44 of the image processing apparatus 10 shown in FIG. 6 with a shape changing unit for changing object shapes. Moreover, while the embodiment has dealt with the case of displaying the Earth, the present invention is not limited thereto but may be used in showing any spherical object. In any case, the origin O is set at the center of the spherical object to be created.

According to the present invention, it is possible to improve the reality of moving images created by computer graphics. In another respect, new graphic effects can be achieved on computer-graphics moving images.

What is claimed is:

1. An image processing method in which a moving image is generated by using 3D computer graphics, the method comprising applying nonlinear coordinate transformation to original moving-image data.

2. An image processing apparatus which generates a moving image by using 3D computer graphics, comprising:
an object classification unit which classifies a plurality of objects included in an original moving image into a first object and a second object to be rendered relatively larger and smaller, respectively; and
a transformation unit which applies nonlinear coordinate transformation to an object classified as the first object.

3. An image processing apparatus which generates a moving image by using 3D computer graphics, comprising:
an object classification unit which classifies a plurality of objects included in an original moving image into a first object and a second object having relatively larger and smaller amounts of movement, respectively; and
a transformation unit which applies nonlinear coordinate transformation to an object classified as the first object.

4. The image processing apparatus according to claim 2, wherein
the transformation unit does not apply the nonlinear coordinate transformation to the second object, and
the image processing apparatus further comprises a positional relationship adjustment unit which makes the positional relationship between the first and second objects in the original moving image be reflected in the positional relationship between the first object given coordinate transformation and the second object given no coordinate transformation.

5. The image processing apparatus according to claim 3, wherein
the transformation unit does not apply the nonlinear coordinate transformation to the second object, and
the image processing apparatus further comprises a positional relationship adjustment unit which makes the positional relationship between the first and second objects in the original moving image be reflected in the positional relationship between the first object given coordinate transformation and the second object given no coordinate transformation.

6. The image processing apparatus according to claim 2, wherein
the transformation unit applies nonlinear coordinate transformation to the first object before the unit applies nonlinear coordinate transformation to the second object.

7. The image processing apparatus according to claim 3, wherein
the transformation unit applies nonlinear coordinate transformation to the first object before the unit applies nonlinear coordinate transformation to the second object.

8. An image processing apparatus which generates a moving image by using 3D computer graphics, comprising:
an object classification unit which classifies a plurality of objects included in an original moving image into a first object and a second object to be rendered relatively larger and smaller, respectively; and
a transformation unit which changes the shape of an object classified as the first object.

9. An image processing apparatus which generates a moving image by using 3D computer graphics, comprising:
an object classification unit which classifies a plurality of objects included in an original moving image into a first object and a second object having relatively larger and smaller amounts of movement, respectively; and
a transformation unit which changes the shape of an object classified as the first object.

10. The image processing apparatus according to claim 8, wherein
the transformation unit does not change the shape of the second object, and
the image processing apparatus further comprises a positional relationship adjustment unit which makes the positional relationship between the first and second objects in the original moving image be reflected in the positional relationship between the first object changed in shape and the second object unchanged in shape.

11. The image processing apparatus according to claim 9, wherein
the transformation unit does not change the shape of the second object, and
the image processing apparatus further comprises a positional relationship adjustment unit which makes the positional relationship between the first and second objects in the original moving image be reflected in the positional relationship between the first object changed in shape and the second object unchanged in shape.

12. The image processing apparatus according to claim 8, wherein
the transformation unit changes the shape of the first object before the unit changes the shape of the second object.

13. The image processing apparatus according to claim 9, wherein
the transformation unit changes the shape of the first object before the unit changes the shape of the second object.

14. The image processing apparatus according to claim 8, wherein
the transformation unit changes the shape of the object while applying nonlinear coordinate transformation to the object so that an area rendered as a plane has a desired curvature.

15. The image processing apparatus according to claim 9, wherein
the transformation unit changes the shape of the object while applying nonlinear coordinate transformation to the object so that an area rendered as a plane has a desired curvature.

16. The image processing apparatus according to claim 10, wherein
the transformation unit changes the shape of the object while applying nonlinear coordinate transformation to the object so that an area rendered as a plane has a desired curvature.

17. The image processing apparatus according to claim 11, wherein
the transformation unit changes the shape of the object while applying nonlinear coordinate transformation to the object so that an area rendered as a plane has a desired curvature.

18. The image processing apparatus according to claim 12, wherein
the transformation unit changes the shape of the object while applying nonlinear coordinate transformation to the object so that an area rendered as a plane has a desired curvature.

19. The image processing apparatus according to claim 13, wherein
the transformation unit changes the shape of the object while applying nonlinear coordinate transformation to the object so that an area rendered as a plane has a desired curvature.
